(19) United States
(12) Patent Application Publication
(10) Pub. No.: US 2020/0352689 A1
(43) Pub. Date: Nov. 12, 2020

(54) DENTAL PICK LOGGER AND COUNTER

(71) Applicant: Gregory Dawes, Lakeland, FL (US)

(72) Inventor: Gregory Dawes, Lakeland, FL (US)

(21) Appl. No.: 16/403,515

(22) Filed: May 4, 2019

Related U.S. Application Data
(60) Provisional application No. 62/666,885, filed on May 4, 2018.

(51) Int. Cl. A61C 15/02; A61C 19/00

(52) U.S. Cl. CPC A61C 15/02; A61C 19/00

(57) ABSTRACT

A dental pick logger and counter is described. In some examples, a dental pick logger and counter can include a microcontroller unit and a sensor, wherein the sensor, upon detecting a dental pick, can trigger the dental pick logger and counter to update a dental pick log by incrementing an existing dental pick count and recording the date/time of each detection. The dental pick logger and counter can also include a display to present the updated dental pick count. The dental pick logger and counter can further include a speaker/buzzer, a battery, and mounting hardware. The display and the speaker can provide feedback to a user of the dental pick. In some examples, the microcontroller unit can be enabled to send the updated dental pick count over a network using a messaging protocol and connected to a global positioning system (GPS) to track a location of the dental pick logger and counter in some implementations.

### RELATED APPLICATIONS

This application claims the benefit of U.S. Application No. 62/666,885, entitled “Dental Pick Logger,” and filed on May 4, 2018, which is incorporated herein by reference in its entirety.

### FIELD

Some implementations relate generally to dental hygiene tools and accessories, and more particularly, to a dental pick logger and counter and a method for logging and counting dental picks.

### BACKGROUND

Dental picks may be commonly used to remove pieces of food or other substances stuck between teeth. For example, dental picks are used to remove pieces of meat or vegetables stuck between the teeth after a meal. They may also be used to remove plaque deposited on the teeth.

Commonly used dental picks are typically discarded after use by their users. Users of dental picks usually do not track the number of dental picks used nor do they track when or where the dental picks are used. However, tracking the location and frequency of used dental picks may help users and/or their dentists monitor a user's dental hygiene and/or dental habits.

It may be desirable to provide a dental pick logger and counter to log instances of use of dental picks along with the number of dental picks used within a predetermined period and related details. Some implementations were conceived in light of the above-mentioned limitations, needs, or problems, among other things.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Some implementations include a dental pick logger and counter. A dental pick logger and counter can include a microcontroller unit and a sensor, wherein the sensor, upon detecting a dental pick, can trigger the dental pick logger and counter to update a dental pick count by incrementing an existing dental pick count. The dental pick logger and counter can also include a display, wherein the display can present the updated dental pick count. The dental pick logger and counter can further include a speaker, a battery, and mounting hardware. The display can be configured with a light that can be automatically turned on when ambient light level falls below a predetermined threshold. The speaker can be configured to play one or more audio files. The display and the speaker can be configured to provide feedback to a user of the dental pick.

The sensor can be connected to an input port of the microcontroller unit. The display and the speaker can be connected to output ports of the microcontroller unit. The display can be an organic LED (OLED) in some implementations. In some implementations, the microcontroller unit can be enabled to send the updated dental pick count over a network using a messaging protocol. The microcontroller unit can be connected to a global positioning system (GPS) to track a location of the dental pick logger and counter in some implementations.

Some implementations include a dental pick logger and counter. A dental pick logger and counter can include a microcontroller unit and a sensor, wherein the sensor, upon detecting a dental pick, can trigger the dental pick logger and counter to update a dental pick count by incrementing an existing dental pick count. The dental pick logger and counter can also include a display, wherein the display can present the updated dental pick count. The dental pick logger and counter can further include a buzzer, a battery, and mounting hardware. The display can be configured with a light that can be automatically turned on when ambient light level falls below a predetermined threshold. The buzzer can be configured to play audio. The display and the buzzer can be configured to provide feedback to a user of the dental pick.

The sensor can be connected to an input port of the microcontroller unit. The display and the buzzer can be connected to output ports of the microcontroller unit. The display can be an organic LED (OLED) in some implementations. In some implementations, the microcontroller unit can be enabled to send the updated dental pick count over a network using a messaging protocol. The microcontroller unit can be connected to a global positioning system (GPS) to track a location of the dental pick logger and counter in some implementations.

A method for logging and counting dental picks can include detecting a dental pick using a sensor, upon detecting the dental pick, triggering a dental pick logger and counter to update a dental pick count by incrementing an existing dental pick count, displaying the updated dental pick count on a display, storing the updated dental pick count in a microcontroller unit, and transmitting the updated dental pick count over a network using a messaging protocol.

The method can also include playing one or more of audio or audio files using one or more of a speaker or a buzzer. A location of the dental pick logger and counter can be tracked using a global positioning system (GPS). The display can be configured with a light that is automatically turned on when ambient light level falls below a predetermined threshold. The sensor can be connected to an input port of the microcontroller unit, and the display and a speaker can be connected to output ports of the microcontroller unit. The display can be an organic LED (OLED).

### BRIEF DESCRIPTION OF THE DRAWINGS

FIG. 1 is a diagram showing a block view of an example dental pick logger and counter in accordance with some implementations.

FIG. 2 is a diagram showing a top view of an example dental pick logger and counter used in conjunction with a dental pick container in accordance with some implementations.

FIG. 3 is a diagram showing a front view of an example dental pick logger and counter used in conjunction with a dental pick container in accordance with some implementations.

FIG. 4 is a diagram showing a schematic view of an example dental pick logger and counter in accordance with some implementations.

FIG. 5 is a diagram showing a process flow of a method for logging and counting dental picks in accordance with some implementations.

### DETAILED DESCRIPTION

The dental pick logger and counter can log dental pick usage and provide feedback to users through different means, including, for example, lights, sounds and graphics. The dental pick logger and counter can also be constructed to connect to the internet as an “internet of things” (IOT) device so that dental pick usage data can be collected in a mobile application for long-term data storage and tracking. The dental pick logger and counter uses real time data to communicate with users and other stakeholders, such as dentists and dental hygienists, to provide encouragement, reminders and support to users. The dental pick logger and counter not only can help improve oral hygiene habits but also facilitate better recycling of dental picks by tracking usage patterns.

In an example implementation, after a dental pick is used to clean teeth, users deposit the used picks into a dental pick container. At this point, the dental pick logger and counter provides audio-visual feedback and logs the number of dental picks used thus far. The dental pick logger and counter can also display the number of dental picks used thus far along with a message. Features of the dental pick logger and counter, including feedback, can be configured by users.

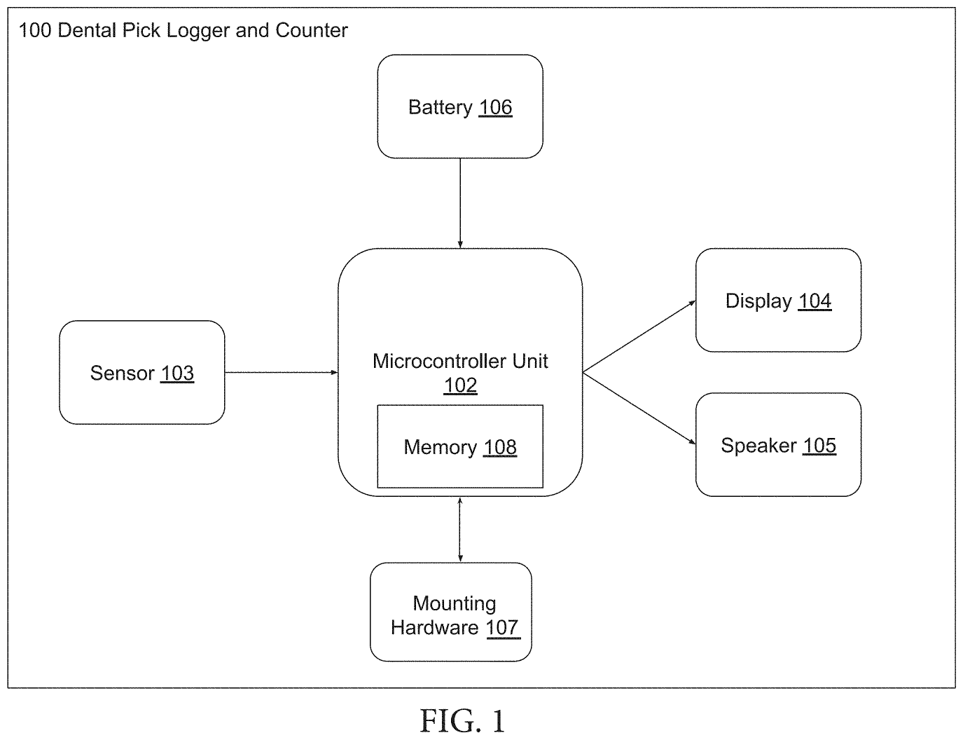

FIGS. 1-5 show diagrams of an example dental pick logger and counter (e.g., 100) and/or components and/or accessories thereof. Such example dental pick logger and counters can, for example, be used by dentists and dental hygienists to monitor dental hygiene habits of their clients or customers, and by users who seek to monitor their own dental hygiene habits. FIG. 1 is a block diagram showing an example dental pick logger and counter in accordance with some implementations. An example dental pick logger and counter 100 shown in FIG. 1 includes a microcontroller unit 102, a sensor 103, a display 104, a speaker 105, a battery 106, mounting hardware 107, and a memory 108 included within the microcontroller unit 102 above mentioned.

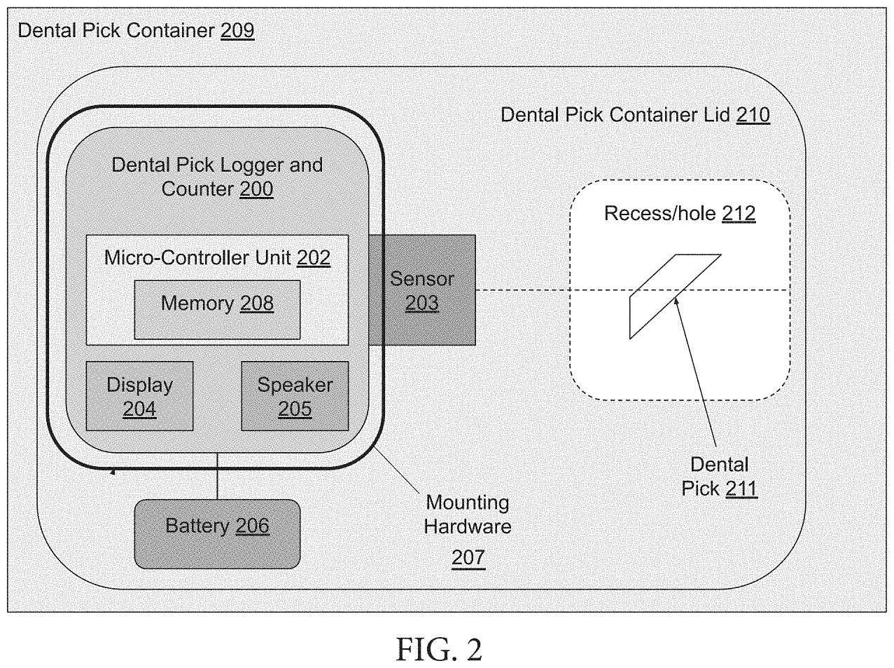

FIG. 2 shows a dental pick container 209 along with a dental pick container lid 210. The dental pick logger and counter 200 is mounted on the dental pick container lid 210 using the mounting hardware 207. When a dental pick 211, after use, is dropped into the dental pick container 209 through a recess/hole 212 in the dental pick container lid 210, the sensor 203 detects the dental pick 211 as it passes via the plane of the sensor. This detection triggers the microcontroller unit 202 to update the count of dental picks in the dental container 209, to store the updated dental pick count in the memory 208 and to display the updated dental pick count on the display 204. The updated dental pick count can optionally be played over the speaker 205. The dental pick logger and counter can be powered by the battery 206, which can be recharged.

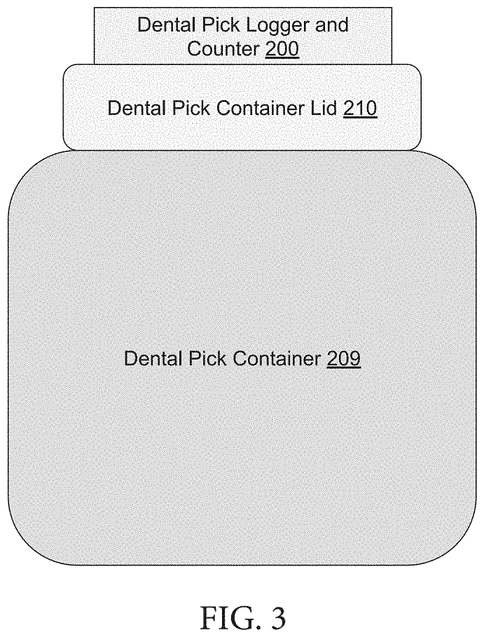

FIG. 3 is a front view of the dental pick container 209 along with the dental pick container lid 210 and the dental pick logger and counter 200 mounted on the dental pick container lid 210.

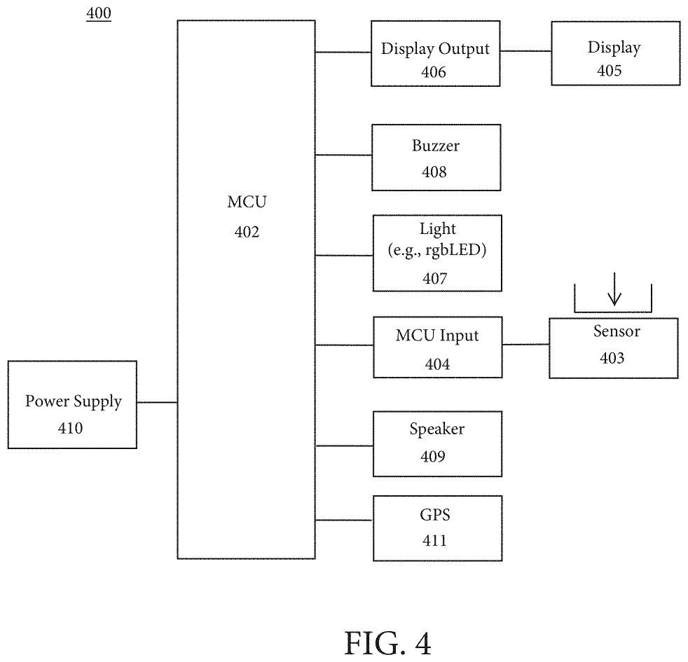

FIG. 4 is a diagram showing a schematic view 400 of an example dental pick logger and counter in accordance with some implementations. FIG. 4 shows a microcontroller unit (“MCU”) 402. For example, nodeMCU and/or Arduino Uno can be used as an MCU. NodeMCU is WIFI enabled and commonly used, for example, within IOT devices. An MCU can use a messaging protocol, for example, the MQTT messaging protocol, to send logged data over a network.

A sensor 403 can sense a dental pick crossing the plane of a dental pick container and this sensing can trigger the dental pick logger and counter. The sensor can be connected to an MCU input 404 in order for the sensor's data to be captured by the dental pick logger and counter. An organic LED display (“OLED”) 405 can be connected to an MCU output 406 to provide visual feedback. The OLED can be controlled by the MCU and can be configured by users to provide the configured feedback. Examples of feedback include a bar graph representing the fullness of the dental pick container, the discarded dental pick count or a text message related thereto.

In some implementations, an OLED can include a red, green and blue light emitting diode (“rgbLED”) 407 to provide light effect. rgbLED can be controlled by MCU outputs. The MCU can control all aspects of an rgbLED from brightness, color, flashing, duration, on and off. The MCU can also include an on-board LED (surface mounted diode) for additional light effects. The MCU can select a color for the LED and can send the selected color value over the internet.

In some implementations, a buzzer 408 can be used for audio effect. A small speaker 409 can be used to replace the buzzer to play digital audio files like ring tones or voice recordings. MCU can control the buzzer as well as control audio feedback options provided to users. A battery 410 can be used to power the dental pick logger and counter and its components, including, for example, the MCU, the sensor, the OLED, the rgbLED, or the buzzer or speaker.

The dental pick logger and counter can be mounted on/in a dental pick container. An example dental pick container can be a peanut butter jar. Other types of dental pick containers of different sizes, shapes, and/or colors may be used depending on a contemplated implementation. Optionally, a GPS unit 411 can be incorporated into the dental pick logger and counter device to enable tracking of the location where each dental pick is discarded into the dental pick container.

The dental pick logger can also include miscellaneous wiring and mounting hardware along with a dental pick container lid with cutouts/holes for mounting the dental pick logger and counter. In some implementations, all components of the dental pick logger and counter can be combined onto one board, which can then be mounted on the lid of the dental pick container.

In some implementations, the method for logging and counting dental picks is written in Arduino Integrated Development Environment (“IDE”) for the MCU. The IDE then compiles the method into machine language and uploads the machine language to the MCU. Also, the method can be uploaded to the MCU through a mobile application developed for that purpose. Also, in some implementations, a NodeMCU can include a WIFI chip, an antenna and memory. In some implementations, the battery can be rechargeable. In some implementations, a photoresistor can be used to sense changes in light and turn on a nightlight at low light levels. This photoresistor can be controlled by the MCU and work independently of the rest of the device.

The dental pick logger and counter can be a device in some implementations. It will be appreciated that the dental pick logger and counter described herein is for illustration purposes only and is not intended to be limiting. Other dental pick logger and counters may be used depending on a contemplated implementation. It will be appreciated that the microcontroller unit, the sensor, the display, the buzzer, the speaker, the battery, the mounted hardware, and the GPS described herein are for illustration purposes only and are not intended to be limiting. Other types of such hardware/devices may be used depending on a contemplated implementation.

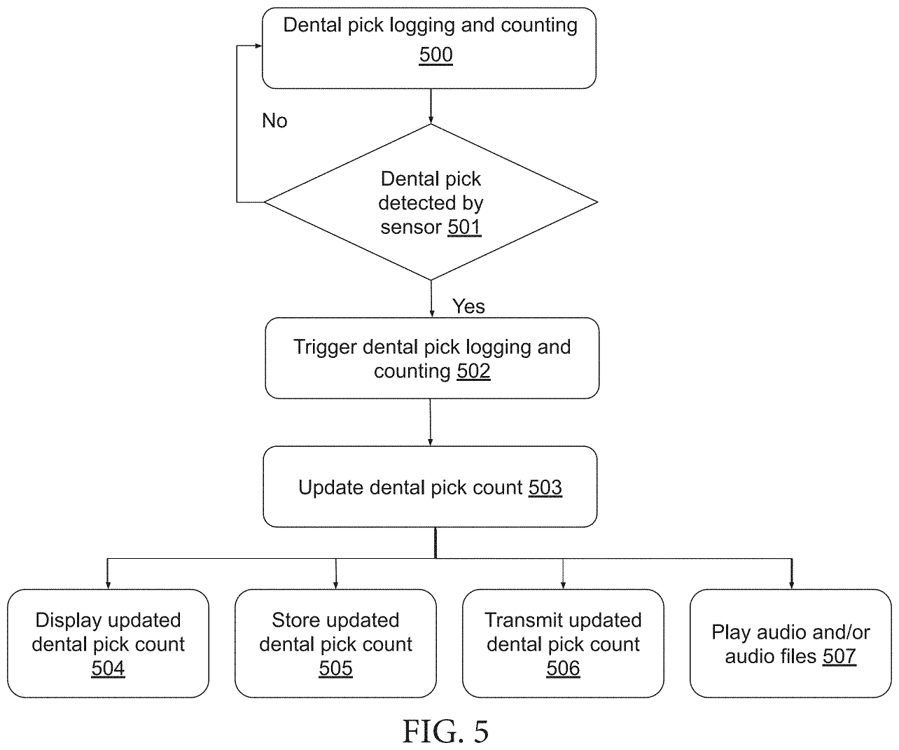

An example process/method for logging and counting dental picks shown in FIG. 5 can include detecting a dental pick using a sensor (501), and upon detecting the dental pick, triggering a dental pick logger and counter (502) to update a dental pick count by incrementing an existing dental pick count (503). In some implementations, one step can include displaying the updated dental pick count (504) on a display. The display can be configured with a light that is automatically turned on when ambient light level falls below a predetermined threshold.

Another step can include storing the updated dental pick count in a microcontroller unit (505), while yet another step can include transmitting the updated dental pick count over a network using a messaging protocol (506). The method can also include playing one or more of audio or audio files (507) using one or more of a speaker or a buzzer. A location of the dental pick logger and counter can be tracked using a global positioning system (GPS).

The sensor can be connected to an input port of the microcontroller unit, and the display and a speaker or a buzzer can be connected to output ports of the microcontroller unit. The display can be an organic LED.

A benefit of the disclosed dental pick logger and counter is that the frequency, location and other data related to use of a dental pick is logged to monitor/track dental hygiene habits and the log can be transmitted to one or more other systems (e.g., a user system and/or a dental health care provider system). The disclosed dental pick logger and counter can be constructed and arranged to operate as an IoT device (e.g., a network connected embedded system) that can communicate the updated log and other information to other systems via a network connection (e.g., wi-fi) to a network (e.g., the Internet).

It will be appreciated that any dimensions described herein are for illustration purposes only and are not intended to be limiting. Other dimensions could be used depending on a contemplated implementation.

It is therefore apparent that there are provided, in accordance with the various example implementations disclosed herein, a dental pick logger and counter as well as a method for logging and counting dental picks.

While the disclosed subject matter has been described in conjunction with a number of implementations, it is evident that many alternatives, modifications and variations would be or are apparent to those of ordinary skill in the applicable arts. Accordingly, Applicant intends to embrace all such alternatives, modifications, equivalents and variations that are within the spirit and scope of the disclosed subject matter.

What is claimed is:

1. A dental pick logger and counter comprising:
a microcontroller unit;
a sensor, wherein the sensor, upon detecting a dental pick, triggers the dental pick logger and counter to update a dental pick count by incrementing an existing dental pick count;
a display, wherein the display presents the updated dental pick count;
a speaker;
a battery; and
mounting hardware.

2. The dental pick logger and counter of claim 1, wherein the display is configured with a light that is automatically turned on when ambient light level falls below a predetermined threshold.

3. The dental pick logger and counter of claim 1, wherein the display and the speaker are each configured to provide feedback to a user of the dental pick.

4. The dental pick logger and counter of claim 1, wherein the speaker is configured to play one or more audio files.

5. The dental pick logger and counter of claim 1, wherein the sensor is connected to an input port of the microcontroller unit, and wherein the display and the speaker are connected to output ports of the microcontroller unit.

6. The dental pick logger and counter of claim 1, wherein the display is an organic LED (OLED).

7. The dental pick logger and counter of claim 1, wherein the microcontroller unit is enabled to send the updated dental pick count over a network using a messaging protocol.

8. The dental pick logger and counter of claim 1, wherein the microcontroller unit is connected to a global positioning system (GPS) to track a location of the dental pick logger and counter.

9. An internet-of-things dental pick logger and counter comprising:
a microcontroller unit configured to communicate to a network via a wireless network interface;
a sensor coupled to the microcontroller, wherein the sensor, upon detecting a dental pick, sends a signal to the microcontroller to update a dental pick log by incrementing an existing dental pick count and log a date and time of detection of the dental pick;
a display, wherein the display presents the dental pick count;
a buzzer;
a battery; and
mounting hardware.

10. The dental pick logger and counter of claim 9, wherein the display is configured with a light that is automatically turned on when ambient light level falls below a predetermined threshold.

11. The dental pick logger and counter of claim 9, wherein the display and the buzzer are each configured to provide feedback to one or more users.

12. The dental pick logger and counter of claim 9, wherein the buzzer is configured to play audio.

13. The dental pick logger and counter of claim 9, wherein the sensor is connected to an input port of the microcontroller unit, and wherein the display and the buzzer are connected to output ports of the microcontroller unit.

14. The dental pick logger and counter of claim 9, wherein the microcontroller unit is enabled to send the updated dental pick log over the network using a messaging protocol.

15. The dental pick logger and counter of claim 9, wherein the display is an organic LED (OLED).

16. The dental pick logger and counter of claim 9, wherein the microcontroller unit is connected to a global positioning system (GPS) to track a location of the dental pick logger and counter.

17. A method for logging and counting dental picks, the method comprising:
detecting a dental pick using a sensor;
upon detecting the dental pick, triggering a processor of a dental pick logger and counter to update a dental pick log by incrementing an existing dental pick count;
displaying the updated dental pick count on a display;
storing the updated dental pick count in a microcontroller unit; and
transmitting the updated dental pick log over a network using a messaging protocol.

18. The method of claim 17, wherein a location of the dental pick logger and counter is determined using a global positioning system (GPS), and wherein the updated dental pick log includes the location.

19. The method of claim 17, wherein the display is configured with a light that is automatically turned on when ambient light level falls below a predetermined threshold.

20. The method of claim 17, further comprising:
playing one or more of audio or audio files using one or more of a speaker or a buzzer,
wherein the sensor is connected to an input port of the microcontroller unit,
wherein the display and a speaker are connected to output ports of the microcontroller unit, and
wherein the display is an organic LED (OLED).
